(19) United States
(12) Patent Application Publication
(10) Pub. No.: US 2003/0023952 A1
(43) Pub. Date: Jan. 30, 2003

(54) Multi-task recorder

(76) Inventor: Charles Reid Harmon JR., Andrerson, SC (US)

Correspondence Address: BROBECK, PHLEGER & HARRISON, LLP, ATTN: INTELLECTUAL PROPERTY DEPARTMENT, 1333 H STREET, N.W. SUITE 800, WASHINGTON, DC, 20005, US

(21) Appl. No.: 09/782,275

(22) Filed: Feb. 14, 2001

(51) Int. Cl. G06F 9/44; G06F 9/45

(52) U.S. Cl. 717/106; 717/115; 717/110

(57) ABSTRACT

A method, system, and computer-readable medium controls one or more applications in a graphical user interface type operating system. All events that occur through the graphical user interface are recorded and a script file is generated comprising instructions based on the recorded events. A compiler compiles the script file into a binary language file; and an event player executes the binary language file to control the one or more computer applications according to the instructions. In a preferred embodiment, all mouse and keyboard events that occur through a graphical user interface in a Windows, MacOS, or X-windows based operating system are recorded. The above events are created directly or indirectly by a user of the graphical user interface.

### BACKGROUND OF THE INVENTION

1. Field of the Invention

The invention relates to a method, computer-readable medium, and system for automating and controlling one or more computer applications. Particularly, the invention relates to automating tasks, testing applications, or presenting live application demonstrations in a Microsoft Windows® type operating system.

2. Description of Background

An interface is a point at which a connection is made between two elements so that they can work with each other. In computers, an interface is provided by software to enable a program to work with a user, with another program such as the operating system, or with the computer's hardware. For example, graphical user interfaces, command interfaces, and batch interfaces are all types of computer interfaces. The modem graphical user interface, popularized by Apple Computers®, is about twenty years old. Before the existence of graphical user interfaces there were batch and command interfaces.

In a batch interface, the user initially specifies all the information needed to perform one or more tasks, and the application performs all the tasks without consulting the user for more information. A batch program contains a sequence of operating-system commands, possibly including parameters and operators supported by a batch command language. When a user executes a batch program, the commands are processed sequentially. Many applications, such as utilities, utilize batch interfaces. For example, before WinZip®, which uses a graphical user interface, there were DOS utilities called pkzip and pkunzip, by PKWare®, Inc., having batch interfaces that performed the same functions. In the operation of these batch interface utilities, the user specifies the name of a ZIP file and all appropriate files and parameters on the command-line, so that pkzip or pkunzip executes, checks to make sure that the user's instructions made sense and are logical, performs all the tasks specified, and then exits. An advantage of batch interfaces is that they operate on their own without user interaction.

A command interface is a form of interface between the operating system and the user in which the user types commands using a special command language. For example, MS-DOS®, which is an acronym for Microsoft Disk Operating System is a single-tasking, single-user operating system with a command-line interface for IBM PCs and compatibles. MS-DOS, like other operating systems, oversees operations such as disk input and output, video support, keyboard control, and many internal functions related to program execution and file maintenance. In a command interface, a prompt is displayed and the user types a request to the executing application. The application either complies or prints an error, and returns the prompt.

Operating systems using command interfaces also provide a way of using a command interface as a batch interface, which is commonly known as input redirection. Instead of typing all of the commands to the command interface, it is possible to put them in a plain text file, and then send the text file to the command interface application as if the user were typing the contents of the file. These types of operating systems provide a direct way of doing this via their own interface. For example, DOS has batch files, Unix has shell scripts, and Virtual Memory Operating Systems (“VMS”) have Digital® Command Language (“DCL”) files. Therefore, command interfaces are able to be used as easily as batch interfaces. Although systems with command-line interfaces are usually considered more difficult to learn and use than those with graphical interfaces, command-based systems are usually programmable; thus, giving flexibility unavailable in graphics-based systems that do not have a programming interface.

A graphical user interface (“GUT”), e.g., Microsoft Windows, is a type of enviromnent that represents programs, files, and options by means of icons, pull-down menus, buttons, text fields, dialog boxes, and the like on a terminal screen. A user can select and activate these options by pointing and clicking with a mouse or, often, with the keyboard. A particular item, such as a scroll bar, works the same way to the user in all applications because the graphical user interface provides standard software routines to handle these elements and report the user's actions, such as a mouse click on a particular icon or at a particular location in text, or a key press. In operation, applications call these routines with specific parameters rather than attempting to reproduce them from scratch.

For example, this document was written in MS-WORD®), which is a GUI-based word processor. In operation, the user may open, edit, and save files all through a graphical interface. Further, the user can type the text of the document in the main window and command the program to do things such as save the file or change the font through the use of the program's graphical controls.

The idea behind graphical user interfaces was to have the user interact more directly with the application. For example, the instantaneous visual feedback and ease-of-use has made graphical user interfaces very popular. But while applications can be launched from a command prompt in Windows (via a MS-DOS prompt or the Run option on the Start menu), they don't typically support command or batch interfaces as well. For example, Microsoft Office® applications allow the user to specify the document to open on the command line, which saves a File->Open step, but this is usually the limit of what can be performed on the command line. Therefore, as a computer-literate society, we have gained usability but have lost automation.

Microsoft recognized this fact and introduced objects which could be opened in the scripting languages JScript and VBS which allow the user to send keystrokes to application windows. This, however, is only one step in the right direction. While Windows and Windows-based applications are designed to use the keyboard as an alternative to the mouse, this is usually very tedious. Proof of such tediousness can be found by using Windows for an hour without touching the mouse. Therefore, despite Microsoft's efforts and the availability of several simple and basic macro utilities, there has been no way to control Windows applications automatically as if a user were actually sitting in front of the screen.

Application macros have been developed to automate simple tasks in a single application. For example, a macro is a set of keystrokes and instructions recorded and saved under a short key code or macro name. When the key code is typed or the macro name is used, the program carries out the instructions of the macro. Users can create a macro to save time by replacing an often-used, sometimes lengthy, series of strokes with a shorter version.

Stand-alone programs have been developed to allow users to create macros to perform tasks on an operating system level, thereby allowing control of multiple applications. For example, Macro Express® is a software utility that instructs one or more applications to perform a set of tasks. Further, macros can be created either manually or by recording them. A scripting editor is provided that allows each individual command to be modified, deleted, copied, or moved around in the script. However, Macro Express presents problems to a user when using and editing large scripts. For example, because of the complexity of the Macro Express scripting language, editing scripts requires the use of a Macro Express specific editor. Further, the scripting language is designed for computers to understand as opposed to a verbose language that programmers can readily understand. Furthermore, the variables used in Macro Express scripts are limited in number and in name. For example, a user can not specify a variable name other than what is allowed by the program, such as N1-N40. Therefore, programming in this script language without the use of a Macro Express editor is very difficult. Moreover, Macro Express scripts are easily viewable and are able to be modified which presents problems if security is concerned, or if third party vendors desire to offer macros for commercial purposes without revealing their programming techniques. In addition, a Macro Express playback program is required to either be loaded in a separate step before the macro is executed, and the exited, or it has to run all the time, thereby consuming valuable system resources.

U.S. Pat. No. 6,099,317 to Bullwinkel et al. (“Bullwinkel”) discloses a device that interacts with target applications. Particularly, a series of events are recorded, and the playback mechanism reads and processes each one of them, in order, until it gets to the end. The recorded events enable users on the same or different machines to repeat the recorded events at a future time. Nevertheless, Bullwinkel does not allow a different stream of events to be generated based on the state of the GUI and even files on disk at the time of playback. Therefore, if the playback state of the GUI is not the same as the state when recorded, playback of the recorded events will not function properly. Further, the recorded events are not allowed to be edited or modified. Furthermore, Bullwinkel is intended to be used in a controlled training environment and accordingly is inoperable in a changing environment.

### SUMMARY OF THE INVENTION

The present invention is directed to a method, system, and computer-readable medium to automate tasks, test applications, and present live application demonstrations in a Microsoft Windows type operating system.

It is an object of the invention to interact with Windows and multiple Windows applications on a user's behalf, to free the user from performing a set of tasks manually, and to control Windows applications automatically as if a user were actually sitting in front of the screen.

In an embodiment of the invention, a method for controlling one or more computer applications in a graphical user interface type operating system comprises the steps of: generating a script file comprising instructions for controlling one or more computer applications; compiling the script file into a binary language file; and executing the binary language file to control the one or more computer applications according to the instructions. The method can further comprise the steps of editing the script file to modify the instructions; recompiling the edited script file into a second binary language file; and executing the second binary language file to control the one or more computer applications according to the modified instructions.

In a preferred embodiment, the above method comprises the step of recording all mouse and keyboard events that occur through a graphical user interface in a Windows, MacOS, or X-windows based operating system. The events recorded comprise key presses, key releases, mouse button presses, mouse button releases, and mouse movements. All events are created directly or indirectly by a user of the graphical user interface. The method further records an elapsed time between sequential events, and a configuration of each open window comprising size and position information. In addition, the method may further comprise the steps of: determining whether the one or more applications are closed; and based upon the determination, opening the closed applications.

A feature of the invention is that the steps of generating the script file, compiling the script file and executing the binary language file do not have to occur on the same computer. For example, a script can be generated on one computer and then sent to another computer for compilation or playback.

In another embodiment of the invention, a system for controlling one or more applications in a graphical user interface type operating system comprises: an event recorder, a compiler, and an event player. The event recorder records all events that occur through the graphical user interface and generates a script file comprising instructions based on the recorded events. The compiler compiles the script file into a binary language file; for execution by the event player so that one or more computer applications are controlled according to the instructions.

In a preferred embodiment, the event recorder records all mouse and keyboard events that occur through a graphical user interface in a Windows, MacOS, or X-windows based operating system. All events are created directly or indirectly by a user of the graphical user interface. The event recorder further records an elapsed time between sequential events, and a configuration of each open window. The event recorder may also be enabled to insert instructions into the script, such as, instructions to open a desired application if that application is found to be closed during playback. Further, the system may comprise a means for storing the script file and the binary language file in a storage medium and a means for sending the script or the binary language file from a first computer to a second computer.

In another embodiment of the invention, a computer-readable medium having computer-executable instructions thereon controls one or more computer applications in a graphical user interface type operating system. The instructions comprise modules including: a recording module for recording all events that occur through the graphical user interface and for generating a script file comprising instructions based on the recorded events; a compiling module for compiling the script file into a binary language file; and an executing module for executing the binary language file to control the one or more computer applications according to the instructions.

In a preferred embodiment, the above computer-readable medium comprises instructions for recording all mouse and keyboard events that occur through a graphical user interface in a Windows, MacOS, or X-windows based operating system. These events are created directly or indirectly by a user of the graphical user interface. The recording module comprises instructions for recording an elapsed time between sequential events and a configuration of each open window. Further instructions in the recording module are directed to opening an application if the application is found to be closed during playback. The computer-readable medium can further comprise instructions for storing the script file and the binary language file in a storage medium.

An advantage of the invention is that events can be generated completely synthetically. Another advantage is that the playback/executor mechanism can generate a different stream of events based on runtime criteria such as: the application(s) open; the size, position, state, or appearance of the open windows in the GUI; the contents of any and all files on local or network disks; and the contents of the system registry.

The foregoing, and other features and advantages of the invention, will be apparent from the following, more particular description of the preferred embodiments of the invention, the accompanying drawings, and the claims.

### DESCRIPTION OF THE FIGURES

FIG. 1 depicts the steps of recording, creating, editing, compiling, and playing macro scripts according to a preferred embodiment of the invention.

FIG. 2 illustrates the step of recording a macro script according to a preferred embodiment of the invention.

FIG. 3 illustrates the step of compiling a macro script according to a preferred embodiment of the invention.

FIG. 4 illustrates general playback of the compiled macro script according to a preferred embodiment of the invention.

FIG. 5 depicts a flowchart illustrating the steps of playing a compiled macro script according to a preferred embodiment of the invention.

### DESCRIPTION OF THE INVENTION

The preferred embodiments of the invention are now described with reference to the figures where like reference numbers indicate like elements. Also in the figures, the left most digit of each reference number corresponds to the figure in which the reference number is first used.

These preferred embodiments of the invention are discussed in the context of applications executing on a Windows type operating system. Nevertheless, the invention can be practiced in other operating systems employing graphical user interfaces, such as Apple's MacOS®, X-Windows, and the like, provided that the graphical user interface or the underlying operating system provides mechanisms for reading and posting system-level events. X-Windows may be used on Unix variant systems including Linux. Each figure shows one or more events that happen at different times on perhaps an entirely different computer.

In a preferred embodiment of the invention, a set of computer programs (collectively referred to as “WinReach”) are operable to control Windows applications. The set of programs comprise a recorder program, a compiler program, and a player program. In an alternative embodiment, the set of programs are combined into a single application, for example, an application that when executed, displays a record button, a compile button, and a playback button together in a single window. Because each program performs tasks independently, each program will be discussed individually.

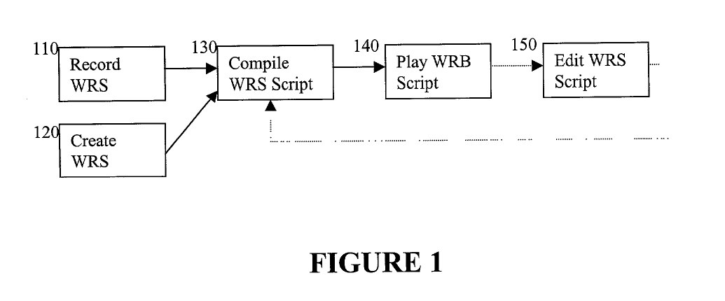

As an overview, the recorder program is operable to record keyboard and mouse events during a desired time frame. In operation, the recorder generates a WinReach script file (“WRS”) containing information reflective of the recorded events. In other words, the WRS file contains a set of instructions, which during playback, control one or more applications in Windows. The compiler program is operable to compile the WRS file into a WinReach byte-code (“WRB”) file format which the player program can execute to control one or more desired applications in Windows. FIG. 1 depicts the steps of recording, creating, editing, compiling, and playing macro scripts according to an embodiment of the invention.

Referring to FIG. 1, a WRS file is created by recording a sequence of keyboard and mouse events using the recorder at step 110. Alternatively, the WRS file is created entirely from scratch at step 120 without the use of the recorder. For example, a WRS file may be created by a programmer using a text editor or the like. The WRS file may be written by a programmer or generated by the recorder in a WinReach scripting language using English-like commands that instruct Windows applications to perform in a specified manner. A detailed discussion of the WinReach scripting language follows. Once a WRS file is created, the WRS file is compiled at step 130 into a machine-readable WRB file. In other words, the WRS file is translated from an English-like language to a machine-like language. WRB files cannot be edited directly by a user, but they can be played at step 140 by a WinReach Player. If any changes are necessary, the WRS file is edited at step 150 and recompiled by repeating step 130, thereby creating another WRB file. Once the WRB file “works” the way a user intends it to, the WRB file can be executed over and over.

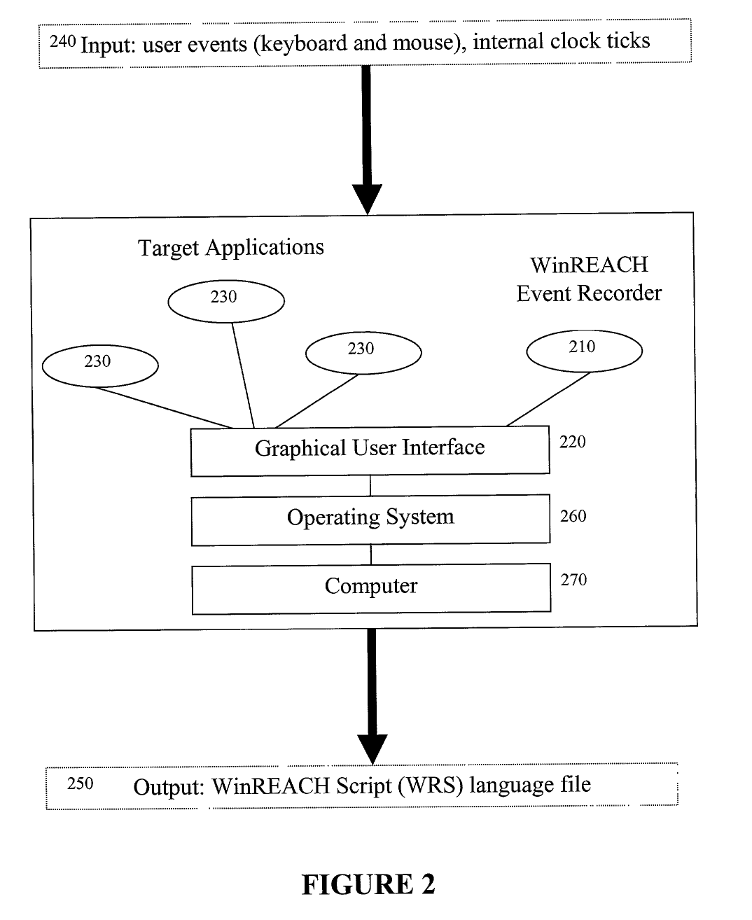

As shown in FIG. 2, recording step 110 is achieved by the use of event recorder 210. Event recorder 210 interacts with GUI 220, or lower levels if necessary, on operating system 260 of computer 270 to monitor and record the events of separate applications 230 also running on the GUI. Lower levels refer to tasks that the operating system does “out of sight” or not readily visible to the user through the GUI. For example, reading and writing files, or allocating and freeing up memory. Broadly stated, recorder can interact with lower levels of the operating system in order to monitor and record events at the GUI level.

Strictly speaking, this permission is always necessary as long as operating system functions are used to gain access to memory or files. For example, in Win9x, permission is always granted. However, in Win 2000, Win ME, or Win NT, permission is dependent on the access granted to different users, e.g., a system administrator as opposed to a general user. Windows stores permission information for each file and each registry entry, i.e., a listing of users that have access to a file and how access is enabled. Windows also tracks each executing program and how the program is executed. Startup programs, for example, can run with administrator permissions, while programs started by the user only run with that user's permissions. When a program tries to open a file via an application programming interface (“API”) call, Windows checks to see which user is associated with the program and if that user has permission to open the file. If permission is granted, the API call returns a handle which represents the file. All operations on the file use the handle as a reference. However, if the user does not have permission to open the file, the API call returns a special value which indicates an error. This also happens if the file does not exist. The program then makes another API call to find out the reason why the open request was denied. The answer is a code that indicates “File not Found,” “Permission Denied,” or the like.

Event recorder 210 records all actions and events 240 that a user creates directly or indirectly through GUI 220. For example, when a recording is made, event recorder 210 first records all open windows along with their state, e.g., minimized, maximized, or normal; size; appearance; and position. It then records a sequence of keyboard or mouse events generated by the user over time, including for each event the elapsed time since the previous event according to a system clock. The events recorded comprise key presses, key releases, mouse button presses, mouse button releases, and mouse movements. Further, the various keys and mouse buttons are differentiated from each other by recording a name of the key or button that is pressed or released. If the event involves a window that was not open at the beginning of the recording, it inserts a special tag indicating that the window is supposed to open. When recording is done, a WRS file is written to a storage device. In an alternative embodiment, a WRS file may be generated by other means. For example, the WRS file may be modified from another WRS file, or created from scratch by a programmer or by a program.

To facilitate in the understanding of using a program to generate a WRS file, consider an image, e.g., a complex company logo, saved as a file in graphic interchange format (“GIF”). A program can be written to read the GIF image file and to generate the particular WRS instructions for drawing the image. For example, one of the many instructions might pertain to drawing a long vertical column of black pixels, i.e., a “brushstroke.” The respective WRS instructions for the stroke comprise a mouse move command to position the mouse at the top of the column, a mouse button click to press the drawing stylus against the drawing surface, a mouse move to position the mouse at the bottom of the column, and a mouse button release to lift the stylus from the surface. When the resulting WRS file is compiled and played back in an MS-PAINT window, the graphic is drawn by the events generated from the script. For a complicated image comprising numerous drawing steps, WRS generation via a program is particularly viable because it is generally not feasible to record, at any speed, a user's drawing performance due to the inevitability of the user making at least a few mistakes. Alternatively, generating the WRS script by hand would also be very tedious, as drawing a complex image involves hundreds of separate drawing strokes.

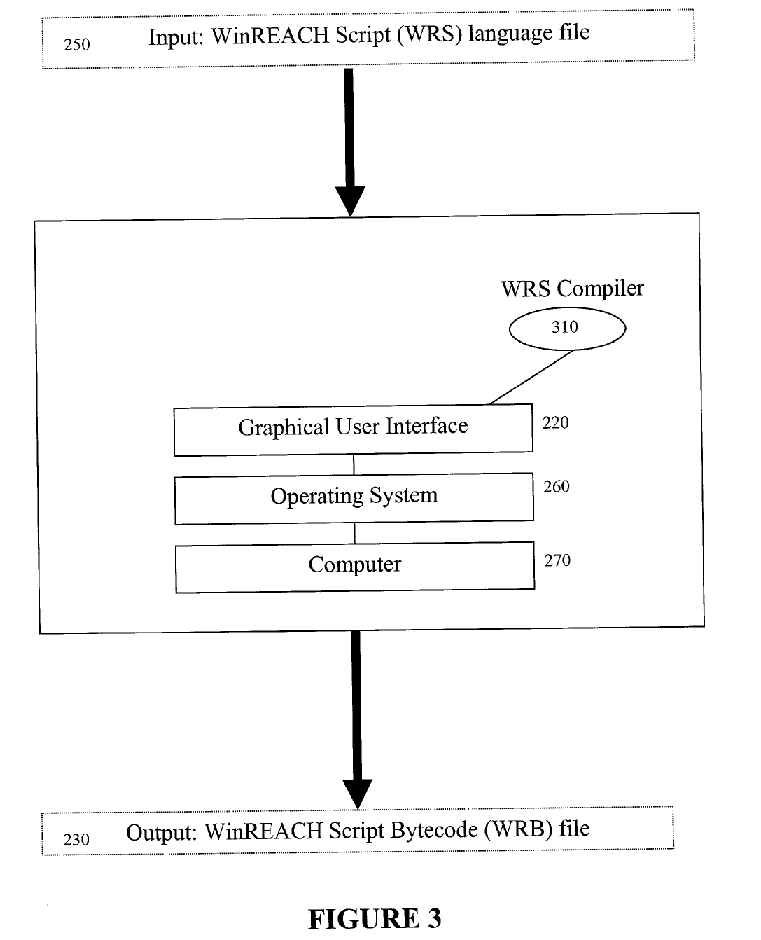

FIG. 3 depicts compiling step 130 for compiling WRS file into WRB file 320 via use of WRS compiler 310 interacting with GUI 220. It is noted that the step of compiling is separate from the recording step. For example, a user could record or create from scratch a WRS script, send it to someone else, who could then compile it on a different computer. The output of a successful compilation is a WRB file. Particularly, a WRB file is a compact form of the WRS which has been designed for efficiency and opaqueness. A portion of the syntax in the WRS file is removed from the WRB file. Commands in the WRB file don't need most syntax elements because an entire word will appear in the WRB as a single byte. Further, generally a next word will appear in a next byte, and there is no need for a separator between the bytes.

Efficiency refers to the feature that execution of the WRB requires negligible syntax checking. For example, the only type of checking that the player does when executing a WRB file, is to track strings and arrays, which are allocated from memory during execution. Therefore, when they are no longer needed, the memory may be returned to the system.

Opaqueness refers to the feature that the WRB file is in binary machine code. Therefore, a human reader viewing this file will not be able to understand the contents when displayed. Assuming that a person will not attempt to change something that they don't understand, the need for the player to check for syntax or type problems is eliminated. In other words, the compiler implements syntax checking rather than the player because the player does not have to “worry” about any changes made to the WRB file. Because the compiler reads what (potentially) a human has created or modified, there may be syntax or type errors. In this context, opaqueness also results in increased efficiency.

The invention is particularly described with reference to a specific scripting language referred to as WinReach Script. One of ordinary skill in the art will recognize, without departing from the inventive concept, that alternative scripting languages may be implemented. For example, a scripting language can be employed that is similar in format to C, Pascal, Fortran, Lisp, or any other programming language. In another embodiment of the invention, a plurality of scripting languages are supported and compiled into WRB format by the compiler. Alternatively stated, the compiler abstracts the execution of the script from the language it's written in. An advantage of this embodiment is that a user is able to play scripts written in different languages, without the user knowing what language a script file is written in, using the same player.

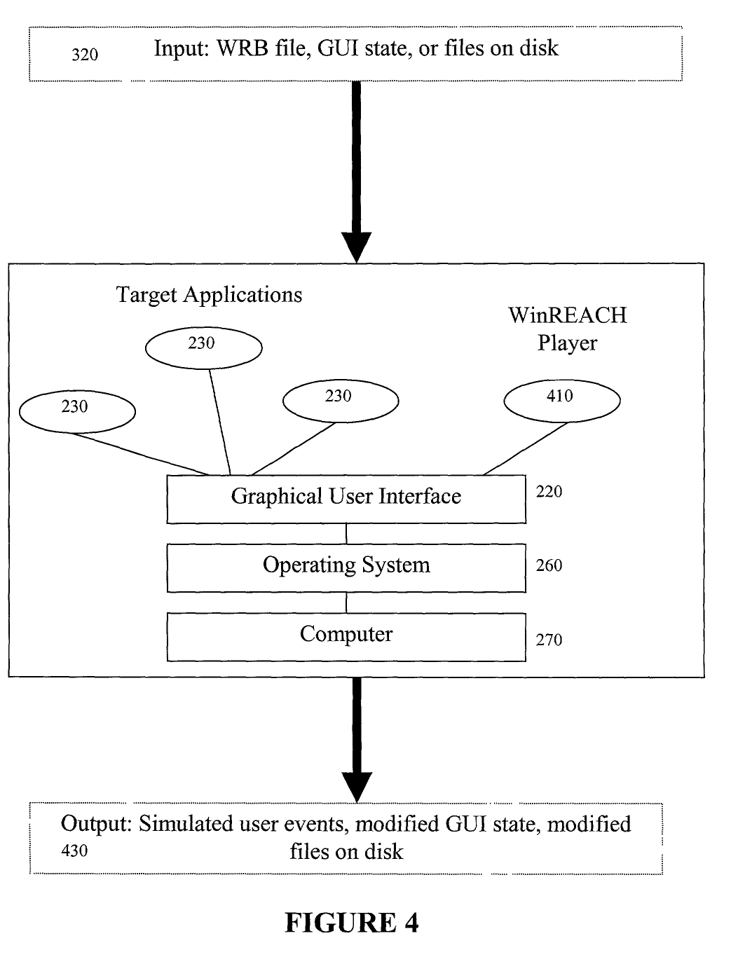

FIG. 4 depicts playback step 140 of WRB file 320. WinReach Player 410 uses input data comprising instructions set forth in the WRB file, the present state of the GUI, and files on disk. Disk files are incorporated explicitly into playback, e.g., player 410 may open one file by name using the command OPENFILE and read its contents with READFILES or READFILEI. For example, the contents of a file content may change between two playbacks occurring at different times. Therefore, the player at the time of the second playback executes differently compared to the first playback. Further, execution or event playback can happen on a computer remote from the recording or compiling location, at a different time, with none, some, or all of the applications running as in FIGS. 2 or 3. In an embodiment of the invention, player 410 performs only the tasks explicitly instructed by the WRB file.

In an embodiment of the invention, player 410 checks to insure that the necessary applications are running prior to execution of the WRB file. Because a script might have been recorded or created for Excel and played back on a computer without Excel running (or even on a computer without Excel installed), it is usually the script programmer's responsibility to insure that Excel is running before any events are sent to it. However, checking is an explicit part of player 410, and the action taken in the event of a problem is determined by the script. For example, possible actions could be opening the necessary program, installing and opening the necessary program, or generating a window indicating the problem.

Alternatively, a script can be explicitly written to make sure the application window is open. For example, if the window is not open, the WRB file (compiled script file) may open a window indicating the problem and then stops. However, the script can be modified, or a new script can be generated from scratch, to behave completely differently. For example, in the above company logo example, a compiled script directs the player to check if MS-Paint is open. If MS-Paint is not open, the script directs the player to open the program and to proceed. Because the controlling medium is a script programming language, the script can be written to respond to different circumstances in different ways.

An advantage of the invention is that a different stream of events are generated depending on the state of the GUI and even the files on disk at the time of the playback. In the former case, the event player can follow a different sequence of actions depending on whether an application is open or closed, maximized or minimized, or even depending on the window's size. For example, the script player can calculate the exact center of a window in order to generate a mouse button click at that spot. The generated event would always occur at the center of the window, regardless of the window's size or position. In the latter case, a different stream of events may be generated depending on the contents of one or more files on disk. For example, the AUTOEXEC.BAT file may be checked to determine whether DOSKEY is launched automatically. The files read by the executing script do not have to exist at compile time, and they may be created by anyone for any purpose.

An executing script can read Windows *.INI files, binary image files, or special data files created just for a particular script. For example, a user can write a script to read a list of image files from an external file, and convert them all to a different format using Adobe Photoshop(®. If one of those image files isn't a format that Photoshop recognizes, the script can be written to either stop or skip it. For example, the script checks to see if an error dialog box opens in Photoshop. As for most programming languages, the WRS script will be only as robust as it's specifically programmed to be.

In an embodiment of the invention, an initial window check and a open-during-execution window check are performed as safety features. Particularly, they make sure that the system events at playback are the same as when they were recorded.

In an alternative embodiment of the invention, event playback speed, may be varied. For example, it is possible to play back a script at twice or half the speed, or at any other rate.

According to the preferred embodiment of the invention, not all input information from an event is saved by the recorder in order to make WRS efficient to program in. Examples of missing information are the target window, target coordinates, and absolute system time. However, in order to send events to the GUI during playback, the missing information must be supplied. Detail of this process is discussed below.

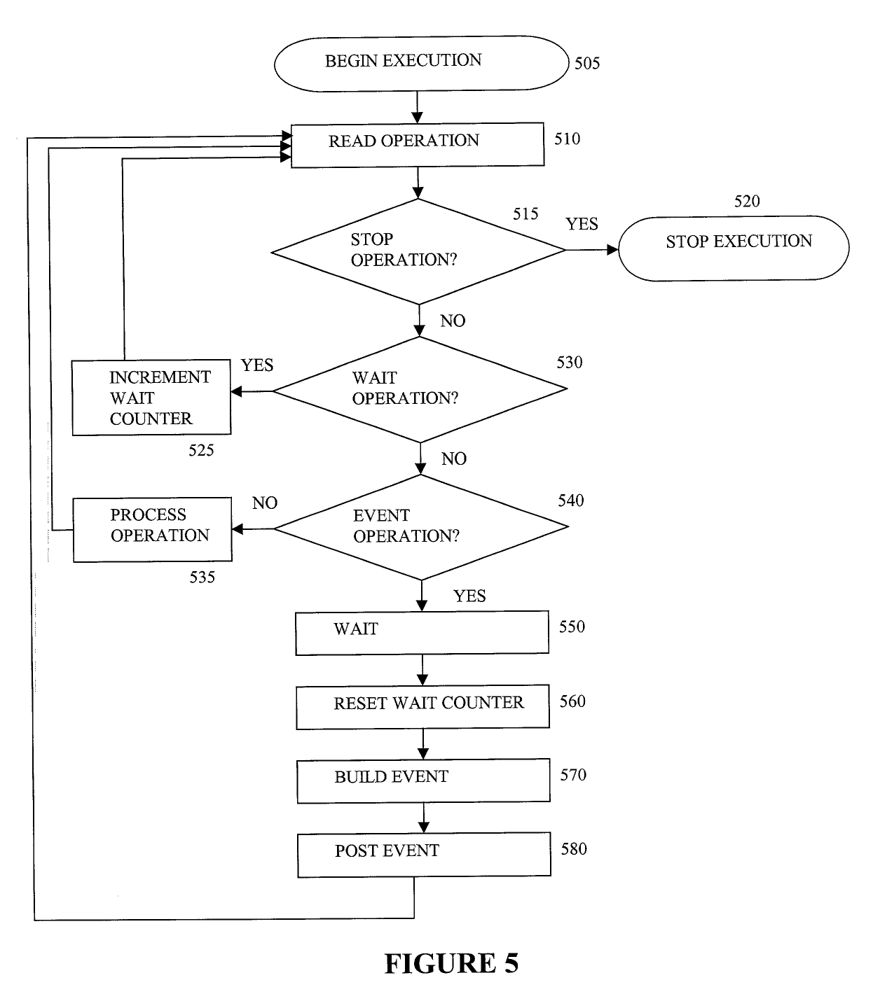

A WRB file is a list of operations, only some of which signify events. FIG. 5 depicts a series of steps for playing back a WRB file. Execution of a WRB file is begun at step 505. At step 510, player 410 reads an operation from the WRB file. All WRB files contain an explicit STOP operation for stopping the execution of the WRB file. Depending on whether a STOP operation is read, player will stop execution at step 520 or proceed to step 530 and check if the operation is a WAIT operation.

One way in which recording simplifies the events is to record not the time of each event, but the span of time between them. This feature is achieved by a WAIT command. During execution, however, the wait time is accumulated and only used during the processing of an event operation. For that reason, a wait counter is used, and a WAIT operation only increments the counter at step 525 by the specified amount of time.

If the event operation is neither a STOP nor a WAIT, it is checked to see if it is an event operation, e.g., a left mouse button press, at step 540. If not, it is a process operation such as an arithmetic operation, a variable lookup or assignment, or control flow, and is processed at step 535. This changes the internal state of the executing script but does not cause an event to be posted to the GUI. If the operation is an event operation, the amount of the wait time accumulated in the counter is used at step 550, and the counter is reset at step 560. Then the event is built at step 570 from the parameters of the operation and the internal state of the machine. As mentioned before, a left mouse button press event included the target window, coordinates, and time. The current set of coordinates is tracked and supplied by the executor program. The executor program queries the GUI for information regarding the window which is on top at those coordinates, and this information identifies the target window. Additionally, an internal clock is kept by the executor and incremented by the wait counter. The value of this internal clock is used as the event time. Once the event is built, it is sent to the GUI at 580 as if the user had generated it.

In addition to task automation, the present invention is useful in the presentation of live application demonstrations, particularly the enhancing or replacing of a standard slideshow presentation, such as those created in Microsoft PowerPoint®. For example, instead of presenting slides describing the features of a product in PowerPoint, a WRB file could show them by executing commands in the application on a demonstration system. Preferably, in the case where the presentation pertains to a computer application, a WRB file could control both a slideshow presentation and the application that the presentation describes, alternating between the two. For example, execution of such a WRB file would enable player 410 to instruct the slideshow presentation application to reveal the next slide, and then it would instruct the demonstration application to perform a task which illustrated the point communicated by the slide.

In another embodiment, the invention is useful to perform application testing, a capability that would benefit both application developers and large client sites. In the former case, a developer can create a WRB file which tests and verifies all the features of an application in development. Then every time that the application is changed, e.g., add a feature, change the interface, or to optimize the application execution, the developer can run the WRB file to ensure that the most recent change has not introduced a logical error, or “bug”, which affects the previous set of features. In the latter case, large client sites often use a single product for data entry and data processing, and they employ many people who are trained to use the product. When new versions of the product are released, often small changes are introduced into the interface which may confuse the employees which use it. A WRB file could therefore verify that the employees will be able to perform a set of tasks the same way on a new version of a product. This check can be performed before the product is installed for all the employees, so that the employees can be instructed in any changes a priori.

### WinReach Script Programming

The WRS file is a sequence of English-like commands that are easy to understand by people, preferably programmers. Generally, commands in WRS are simpler than the events recorded. For example, mouse click events include the type of event, e.g., left mouse button press, target window, screen position, and event time, but the WRS command for a left mouse button press is “LEFTBUTTONDOWN,” while the release is “LEFTBUTTONUP.”

The beginning of the WRS file comprises an initialization section. This section checks to make sure that every window which was open at the beginning of a recording is also open when the script is played back. If the window is not open, an error message may be displayed, and the execution stops. If it is open, the state, position, and size are all set to those at recording time. For example, if a user has the application Notepad open with a file named TODO.TXT when recording begins, and if this user interacts with Notepad during recording, then the generated program will contain the following:

SET h = FINDWINDOW “TODO.TXT - Notepad”
IF h = 0 THEN

MESSAGEBOX “Could not find Notepad window!”
STOP

ENDIF
SETSTATE h NORMAL
SETPOSITION h 157 163
SETSIZE h 360 400

After the initialization section, mouse and keyboard events are translated into their LEFTBUTTONDOWN or LEFTBUTTONUP, etc., counterparts, and elapsed times between events are translated as WAIT commands. If some action on the part of the user during the recording opened a window, the following is inserted into the WRS file:

SET h = FINDWINDOW “TODO.TXT - Notepad”
SET WAITCOUNT = 0
WHILE h=0 AND WAITCOUNT<10 DO

WAIT 50
SET h = FINDWINDOW “TODO.TXT - Notepad”
SET WAITCOUNT = WAITCOUNT + 1

ENDWHILE
IF WAITCOUNT>=10 THEN

MESSAGEBOX “Timed out waiting for window to open!”
STOP

ENDIF

Therefore in the above example, the WRS program doesn't assume that the window has been created; it makes sure, and it times out if something goes wrong.

WRS is a list of commands directing Windows what to do. There are no separators, and it doesn't matter if part of one command is on one line, and the rest of the command is on the next line. Or for that matter, if two commands share a line. Generally, program code is easier for a user, e.g., programmer, to read if the commands are written one per line. An example of a command is:

MOUSEMOVE x y

This command moves the mouse pointer to the screen coordinates (x, y). The values x and y refer to any kind of expression, as long as the expression indicates an integer (whole number, either positive or negative). The units of x and y are pixels, i.e., picture elements. The coordinate system starts at (0,0) in the upper-left corner of the screen and increases to the right and down. If a screen's resolution is 1024×768, then the screen's pixel coordinates range from (0,0) to (1023,767). As an example, if the upper-left corner of an application window is (x, y), the window width is w, and the window height is h, then the command

MOUSEMOVE x+w/2 y+h/2

will move the mouse pointer to the middle of the window.

Expressions are calculations which result in a value. WRS supports four types of values: integer, real, string, and Boolean. Integer values, as stated above, are whole numbers, either positive or negative. Real values are decimal values such as 2.3. String values are sequences of ASCII characters, such as “hello, world.” That particular string value is composed of 13 characters (5 for hello, 1 for the comma, 1 for the space, 5 for world, and 1 for the period). Literal values are constant, uncalculated values in the program. Only non-negative integer and real values can be expressed as literals. The value−1 must be written as an expression: 0−1. Also, while 4 and 4.0 are mathematically equivalent, the literals 4 and 4. 0 represent different types and consequently are stored differently in the system. Literal strings must be enclosed in double quotation marks, as in “hello, world.”. The double quotation marks are not part of the string; they are only used to separate the string from the rest of the program, and identify the value as a string. In other words, “1. 0” is a string type, since the double quotation marks are used. To express a literal string that contains a double quotation mark, the “must be preceded by a backslash, as in “He said to her, \“Nice shoes\”.” The length of the string is 29 characters, since the outer double quotation marks and the backslashes are not counted as part of the string. Because the backslash is used as an escape character, or a character used to identify special characters, to include a backslash in a literal string, the backslash must be preceded by another backslash, as in “C: \\Program Files\\WinREACH\\WRPlay.exe”. The backslash is used to identify many other special characters that are discussed below. Boolean values do not have literals in WRS because they are the result of comparing values of the other three types.

For integer and real values, addition (+), subtraction (−), multiplication (*), and division (/) are all supported. The MOUSEMOVE example above illustrates how the operations are used as in normal mathematical expressions, and the order of operations is the same as for mathematics. For example, multiplication and division have a higher priority than addition and subtraction, so in the expression x+w/2, the division is performed first, even though the addition symbol appears first left to right. Just as in mathematical expressions, parentheses are used to change the order of operations, so in the expression (x+w)/2, the addition is performed first. Value types cannot be mixed in arithmetic operation; they must be either both integer or both real. To add an integer to a real, one must be converted to the other's type with the functions INT and REAL. So REAL (1)+3.2 is an allowed expression, which yields 4.2. Further, the value of the result of one of these operations is the same as the operands, which means that in the case of integer division, only the whole number of divisions is performed. For example, 19/2 is 9, while 19. 0/2. 0 is 9.5. Furthermore, due to the order of operations, REAL (19/2) is 9.0, while REAL(19)/REAL (2) is 9.5.

Strings have similar operators as integers and reals. The addition symbol (+) is used to mean concatenation (joining together) of strings. For example, “Hi”+“there” is equivalent to “Hi there”. As shown, no buffers or spaces are inserted. Strings also have a match symbol (˜) operator. The match symbol compares the first string against the second, which represents a pattern. The result is a Boolean value, which represents either true or false. The result of a match operation is true if the first string matches the pattern represented by the second string, and false otherwise. Pattern matching is explained at great length below.

Boolean values are also obtained by comparing values against one another. For example, the equal sign (=) is an operator that returns true if its operands are equivalent. Its operands must be both integer, both real, or both string. The five other common comparison operators also are supported: not equal (!=), less than (<), less than or equal to (<=), greater than (>), and greater than or equal to (>=). Boolean values also have the special operators represented by the words AND, OR, XOR, and NOT. The AND operator is true only if both of its Boolean operands are true. The OR operator is true if either or both of its Boolean operands are true. The XOR (exclusive-or) operator is true if one but not both of its Boolean operands are true. Finally, the NOT operator takes only one operand, and is true if its operand is false, and vice versa. The utility of Boolean values is made clear in the discussions of the IF and WHILE statements below.

Variables are values which are stored and referred to by name. All variables must be initialized at the beginning of the program with a DECLARE statement. The following example initializes x and s. All DECLARE statements must precede the body of the program. These statements tell the compiler: the names of the variables that will be used (x and s); the types of the variables (x is an integer, and s is a real), which is deduced from the expression signifying the initial value; and the initial values stored in the variables (x is initially 0, and s is initially 0.0).

Variables'types are fixed throughout the program but can change values. The type is used as a double-check to make sure the programmer is using the correct variable and using it the correct way. For example, the expression x+s is illegal because it mixes types. The expression REAL (x)+s is legal, however. To change the value in a variable, the command SET is used, as shown in the example below:

SET s=REAL(3)/REAL(7)

Again, the type of the expression REAL (3)/REAL (7) must match the type of s for the expression to be legal. Assignment of the value to the variable happens after the value of the expression is calculated, so in the example below, x is incremented by 1:

SET x=x+1

Variables can also be arrays. Arrays are collections of scalar, or simple values. Elements of an array variable are referenced through the use of brackets, as shown below.

DECLARE m[50] =2

SET m[50]32m[49]+1

The declaration of arrays fulfills another important function: it specifies the array's default value. In the above example, all elements of m are initially set to 2. When m [49] is referenced, the value 2is used, and so m [50] is set to 3.

The indexes of arrays are general expressions which can be one of two types, e.g., integer and string. Integer indexes, like in the example above, are used for storing continuous values. There is no base for the array and the array grows in either direction as necessary. Initially, the only existing element in the array is the one specified in the declaration. So the statement

SET m[0-34]=m[5] * 7

causes the array to be expanded to include the indexes from−34 to 50. m [−34] is set to be 14, and all of the intermediate elements are initialized with the default value 2. Continuous arrays are efficient only when the intermediate values are needed. If only the elements labeled−34 and 50 are needed, however, it would be more efficient to use a discrete array.

Discrete arrays are indexed by strings, as shown below.

DECLARE m[“50”]=2

SET m[“50”]=m[“49”]+1

SET m[“-34”]=m[“5”] * 7

In the above example, only two elements are actually stored, that of m [“50”] and m [“-34”]. The other elements do not have to be stored unless and until their values change from the default value of 2. Of course, the indexes in discrete arrays are not limited to strings which represent numbers, as shown below.

DECLARE m[“”]=0

SET m[“apple”]=1

SET m[“banana”]=2

SET m[“orange”]=3

Arrays can be multidimensional with no limits on the number of dimensions or the way in which discrete and continuous axes are mixed, as shown below.

DECLARE m[50,””]=0

SET m[50,“apple”]=1

SET m[48,“apple”]=2

SET m[50,“banana”]=3

In the above example, m represents a 2-dimensional space with one continuous axis (with elements labeled 48 to 50) and one discrete axis with two elements.

IF commands direct the program to execute one set of commands versus another, based on the outcome of the evaluation of a Boolean expression. For example:

IF (x>5) THEN

SET s = 5.0

ELSEIF (x<0) THEN

SET s = 0.0
SET x = 0

ELSE

SET s = REAL (x) *1.5
SET x = x + 1

ENDIF

In the example above, one set of commands is executed if x is greater than 5, another if x is less than 0, and a third if neither is true. At most, one set of commands will be executed; the first Boolean expression is evaluated, and the first set of commands is executed if it is true. If the first Boolean expression is false, the ELSEIF Boolean expressions are evaluated in order, and at the first true Boolean expression, the corresponding set of commands is executed. There can be no ELSEIF commands or an unlimited number of them. If the IF Boolean expression and all the ELSEIF Boolean expressions are false, and there is an ELSE clause, the ELSE commands are executed. While the ELSEIF and ELSE clauses are optional, the ENDIF is necessaryto signify the end of the IF command.

WHILE commands are also commonly known as loops, in that the same commands are executed over and over as long as some condition is true. For example, the following will calculate the value of e⁸ and store it in s:

SET x = 0
SET s = 1.0
WHILE (x<8) DO

SET s = s * 2.71828182846
SET x = x + 1

ENDWHILE

It is important to note here that IF statements can be contained in themselves and in WHILE statements, and WHILE statements can be contained in themselves and in IF clauses, as shown:

IF(m>0) THEN

SET i = 0
WHILE (i<n) DO

SET j = 0
WHILE (j<m) DO

IF (i<j) THEN

SET min = i

ELSE

SET min = j

ENDIF
SET max = i+j−min
SET j = j + 1

ENDWHILE
SET i = i + 1

ENDWHILE

ENDIF

### Script Execution Timing

Timing in WRS script execution is controlled by two commands and one pre-declared variable. The command WAIT expr is used to cause execution to pause by expr milliseconds. However, the effect of WAIT is subject to the current value of a pre-declared integer variable called TIMINGOPTION, as shown as follows.

| TIMINGOPTION | Effect on WAIT expr |
|---|---|
| 0 | The command is ignored completely. |
| 1 | The script player waits for the specified number of |
| | milliseconds, immediately. |
| 2 | An internal wait counter is incremented by the |
| | specified number of milliseconds. Before |
| | the next event is posted to the system queue, the script |
| | player waits the total time minus the elapsed time |
| | since the last event was posted. If the total |
| | time is less than the elapsed time since the |
| | last event, then the script player does not wait at all. |
| 3 | The effect is the same as for when TIMINGOPTION |
| | is 2, except that if the total time is less |
| | than the elapsed time since the last event, the |
| | difference is passed ahead to the next event so |
| | that the wait time for that event is reduced as well. |
| 4 | The effect is the same as for when TIMINGOPTION |
| | is 2, except that the |
| | system waits instead of the script player. |
| 5 | The effect is the same as for when TIMINGOPTION |
| | is 3, except that the |
| | system waits instead of the script player. |

The purpose of options 2-5 is to attempt to keep a regular schedule of events, regardless of how long it might take to execute the non-visible parts of the script. For example, consider the following code.

SET x = 0
SET y = 0
WHILE x<200 DO

MOUSEMOVE x y
SET x = x + 1
SET y = y + 1
WAIT 10

ENDWHILE

The intention is that the mouse cursor is dragged in a diagonal line from (0,0) to (199,199) over 200*10 milliseconds, or 2 seconds. Execution of the above code will take longer than 2 seconds, however, if TIMINGOPTION is 1. It takes a negligible amount of time to execute the SET and WAIT commands and to evaluate the Boolean expression x<200, and a significant amount of time for Windows to process the mousemove event in the system queue. If this time adds up to 7 milliseconds, then the user only wants waiting to occur for the remaining 3. If the time adds up to 12 milliseconds for one particular loop iteration, options 2 and 4 will not wait at all and reset the wait counter. Options 3 and 5, on the other hand, will pass the extra 2 milliseconds ahead, so that if the time adds up to 6 milliseconds on the next loop, the 2 leftover from the last loop are included, for a total of 8. Then 10−8=2 milliseconds are waited by the system.

In this way, the individual loop timings are not exact, but the script player tries to average them out over time. The difference between options 2 and 4 (and between 3 and 5) is the question of whether the script player waits or Windows waits. The script player can wait more exactly, but the screen may not reflect the current state of the desktop, since Windows has not retaken control. In other words, the script player may send keys to Notepad, but they may not show up if the script player is doing the waiting. One solution is to periodically force the script player to give control to Windows, which will allow other applications like Notepad to draw the characters of the keys on the screen. Since this synchronizes the script execution with the display, this command is called SYNC.

### WRS Functions

Functions are operations which return a value. They take zero or more arguments, and the result can either be determined from the arguments or from information stored elsewhere on the system. A list of functions in WRS is given below.

FILEATTRIBUTES filename—This function returns a bitmask of attributes associated with the file specified by the string filename.

FILEPOS handle—This function specifies the current position in reading from or writing to a file. It can be used in an expression, or as a parameter to SET (in order to change the position), as shown:

SET FILEPOS (hInFile)=FILEPOS(hInfile)+16

FINDFIRSTWINDOW pattern—This function searches for a window with a title matching pattern and returns the handle for the first. If no window's title matches pattern, a 0 is returned.

FINDFIRSTFILE pattern—This function searches for a file with a name matching pattern and returns the full name for the first. If no such file exists, “” is returned. Note that this function uses WinREACH's pattern-matching function and not the one commonly used in DOS and Windows. For example, “C:\*.*” matches any file in the root C:\directory in DOS and Windows, while “C: \*.* ” matches any file ending in“*” in the C: directory in WinREACH. Even the analogous pattern “C:\\\?\*.\?\*” matches any file containing“.” anywhere on the C: drive, since the first “\?\*” can match directories as well as files. To exclude subdirectories but include files without extensions, the correct pattern would be “c: \\\[\!\\\]\*”. See the section below about how pattern matching works.

FINDNEXTWINDOW—This function takes no parameters. It continues the search initiated by FINDFIRSTWINDOW, returning the next window to match the specified pattern. If no more windows'titles match the pattern, a 0 is returned. The list of window handles returned by FINDFIRSTWINDOW and FINDNEXTWINDOW is determined at the time FINDFIRSTWINDOWis executed. Even if windows are created, destroyed, or change titles in between, the same list is returned.

FINDNEXTFILE—This function takes no parameters. It continues the search initiated by FINDFIRSTFILE, returning the next file name to match the specified pattern. If no more file names match the pattern, “” is returned. The list of file names returned by FINDFIRSTFILE and FINDNEXTFILE is determined at the time FINDFIRSTFILE is executed. Even if files are created, deleted, or if the names are changed in between, the same list is returned.

GETALLTEXT handle—This function returns a string containing all of the text in the window indicated by handle, as well as all of handle's descendants. The string is built recursively for each descendant of handle. If a given window has no descendants, the string returned is the window's text, but if the window does have descendants, the string returned is window text+“\{”+descendant text+“\,”+descendant text+“\,”+. . . +descendant text+“\}”.

GETPIXEL x y—This function returns the color value of the pixel at screen coordinates (x,y). The color value consists of a red, a green, and a blue value, each ranging from 0 to 255, combined by the following formula: RED*65535+GREEN*256+BLUE.

GETWINDOWHANDLE desc—This function looks up the window handle of the window described by the string desc. The description is the window's title, optionally preceded by the window's class and the special character “\:”. For example, when Notepad is opened, a window with the class “Notepad” and title “Untitled-Notepad” opens. The handle for the window can be found with either of the following: GETWINDOWHANDLE “Notepad\:Untitled—Notepad” or GETWINDOWHANDLE “Untitled—Notepad” If no window with a description fitting desc is found, 0 is returned.

GETWINDOWTITLE handle—This function returns the title belonging to the window whose handle is handle. If the window does not exist, “” is returned.

INT expr—This function converts a real or string expression to an integer. Real expressions are truncated; that is, the decimal part is removed. INT 3.4 and INT 3.8 are both 3, and INT (0−3.4) and INT (0−3.8) are both−3. String expressions should begin with an integer, and INT returns the first number in the string. If the string does not start with a number (e.g., “A5”'), then INT returns 0.

LOWERCASE string—converts the string to all lowercase.

NOT bexpr—While NOT is actually an operator, its usage is like a function, so it is included here as well. This function takes a Boolean expression bexpr and returns the logical inverse (i.e., NOT of a true expression is false, and vice versa).

OPENFILE (filename,filemode)—This function opens the file specified by filename using the mode specified by the bitmask filemode. For example, OPENFILE(“TEST.DAT”FM_READ|FM_BINARY) opens TEST.DAT for reading in binary mode, while OPENFILE (“OUTPUT.TXT”FM_WRITE|FM_ASCII) creates the file OUTPUT.TXT for writing in ASCII mode.

POSTMSG handle message wparam lparam—This function sends a message to a window designated by handle. The message number, or type of message, is indicated by message. Messages themselves take two parameters, wparam and lparam. The first parameter, wparam, is an integer, while the second, lparam, can be any type. The meaning of wparam and lparam is specific to the type of message sent. It is beyond the scope of this user's guide to explain message passing in Windows and the various types of messages possible. This function exists for programmers already familiar with message passing in Windows. POSTMSG returns a Boolean value, which is true if the message was successfully delivered.

READFILEI handle—This function reads and returns a 2-byte integer from the binary file specified by handle. In the case of an error, 0 is returned.

READFILES handle—This function reads and returns a string from the binary file specified by handle. Characters are read from the file until an ASCII 0 is read. in the case of an error, “” is returned.

REAL expr—This function converts an integer or string expression to a real. String expressions should begin with an integer or real, and REAL returns the first real in the string. If the string does not start with a number (e.g., “A5”), then REAL returns 0.0.

REGEXISTS keyname—This function returns a Boolean value which is true if the registry keyname specified by the string keyname exists.

REGTYPE keyname—This function returns an integer code corresponding to the entry type of the registry keyname keyname. If the registry keyname does not exist, the value 0 is returned.

REGVALUE keyname—This function returns a string representing the value of the registry keyname keyname. Regardless of the actual registry type, a string is always returned. If the keyname does not exist, “” is returned.

* STRING expr—This function converts an integer or real expression to a string. The simplest string representation is chosen (i.e., the one with the least number of characters), to 6 places after the decimal point.

UPPERCASE string—converts the string to all uppercase.

### WRS Commands

Many useful commands have been discussed above. The following section gives a list of all commands supported by WRS and what they do.

CLOSEFILE handle—This command closes the file specified by handle, which is returned by executing an OPENFILE function (see above).

DECLARE variable=expr—This command declares a variable and initializes it to the value given by expr. All variables used must be declared first, and all DECLARE commands must appear at the beginning of the program.

IF bexpr THEN commands [ELSEIF bexpr THEN commands]* [ELSE commands] ENDIF—This command executes a set of commands conditionally based on the evaluation of Boolean expressions represented by bexpr. Any number (from zero up) of ELSEIF clauses maybe used, and the ELSE clause is optional. This command is discussed in greater detail above.

KEYDOWN virtkey—This command places a keypress event in the system queue, just as if the user had pressed the key. The value represents a unique symbol which is independent of the keyboard layout. For example, the colon (:) and semicolon (;) share a key on a standard PC keyboard, but they have unique virtual key codes. Conversely, A and Ctrl-A have distinct ASCII codes, but they both use the same physical key, the A key. To simulate the press of the A key, the script should execute a KEYDOWN 65 followed by a KEYUP 65, since 65 is the virtual key value for the A key. To simulate a Ctrl-A, however, the following commands are necessary:

1. KEYDOWN 17

2. KEYDOWN 6 5

3. KEYUP 65

4. KEYUP 17

The Ctrl key has a virtual key code of 17, so what the commands above actually accomplish is to press (and hold) the Ctrl key, press the A key, release the A key, and release the Ctrl key, just like a user would do.

KEYUP virtkey—This command places a keyrelease event in the system queue, just as if the user had released the key.

KEYS string—This command generates a series of keypress and keyrelease events, according to the contents of string. Generally, one letter in the string is translated into the appropriate pair of keypress and keyrelease events. If the string contains “a”, then the A key events are generated, but if the string contains “A”, then the A key events are enclosed by a shift keypress and a shift keyrelease. Note that if the CAPSLOCK key is on, this will have the opposite effect of what was intended. Also, some special characters in the string serve as modifiers. The “\&” character encloses the next character by Alt down and Alt up. So “\&fo” generates the following series of events:

1. Alt key down

2. F key down

3. F key up

4. Alt key up

5. O key down

6. O key up

Similarly, the “\” character encloses the next character by Ctrl down and Ctrl up. And finally, “\#” is another way of affecting a shift, but it is only needed for combinations of control keys, such as “\#\t” for Shift+Tab. (“\t” represents the Tab key; a list of special string characters is given in Appendix A.) In order to keep the key events spaced apart, two variables are used by KEYS to regulate timing, KEYHOLDTIME and KEYPAUSETIME. KEYHOLDTIME is the amount of time a pressed key is held before it is released, and KEYPAUSETIME is the time waited after a key is released before the next key is pressed. These variables are pre-declared as integers with values of 25 and 35, respectively. The numbers represent the number of milliseconds of time.

LEFTBUTTONDOWN—This command places a left mouse button down event in the system queue, just as if the user had pressed on the button.

LEFTBUTTONUP—This command places a left mouse button up event in the system queue, just as if the user had released the button.

MESSAGEBOX string—This command pops up a message box illustrating the message string and allows the user to click the OK button before execution in the script resumes.

MOUSEMOVE x y—This command moves the mouse cursor to the coordinates at the screen specified by the expressions x and y.

RIGHTBUTTONDOWN—This command places a right mouse button down event in the system queue, just as if the user had pressed on the button.

RIGHTBUTTONUP—This command places a right mouse button up event in the system queue, just as if the user had released the button.

SENDMSG handle message wparam lparam—This command sends the message with number message to the window indicated by handle. Like the POSTMSG function, the wparam and lparam parameters are specific to the message type. The difference between the two is that SENDMSG waits until the window has processed the message before script execution resumes.

SET variable=expr—This command assigns the value in expr to the variable named variable. The type of expr must match that of the declared type of variable.

SETPOSITION handle x y—This command sets the position of the upper-left comer of the window indicated by handle to the screen coordinates indicated by x and y. The size of the window does not change; the window is moved on the screen.

SETSIZE handle width length—This command sets the size of the window indicated by handle to width by length pixels. The upper-left comer of the window remains fixed; the lower-right comer will move as necessary to change the size.

SETSTATE handle statecode—This command sets the state of the window indicated by handle to either normal, minimized, or maximized. The parameter statecode is an integer, and should be 0 for minimized, 1 for normal, or 2 for maximized. For convenience, three constants are pre-defined to serve as placeholders for statecode: MINIMIZED, NORMAL, and MAXIMIZED.

SHELL string—This command executes a command from the command-line prompt.

START string—This command launches a program or file in Windows as if the user had typed “START string” from the command prompt. Executable files (BAT, COM, and EXE) are executed, and other files are opened with the application with which they are associated.

STOP—This command ends execution of the script.

SYNC—This command synchronizes the execution of the script and the screen display. See the section above on timing in script execution.

WAIT expr—This command causes a pause of expr milliseconds. The effect of this action depends on the value of pre-declared variable TIMINGOPTION. See the section above on timing in script execution.

WHILE bexpr DO commands ENDWHILE—This command executes commands over and over, as long as bexpr is true.

### Pattern Matching

Patterns in WRS use characters to represent themselves, and special characters to represent wildcards, ranges, and repetitions. In other words, the pattern “CaT” will only match the string “CaT”. The special character “\?” represents any character, so the pattern “C\?T” will match “CaT”, “CAT”, “C T”, “C5T”, etc. The special characters “\[” and “\]” indicate a set of acceptable characters. For example, “C\[aA\]T” will match only “CaT” and “CAT”. The above pattern could also be written as “C\|A\)T”. The special characters “\(“and ”\)” provide grouping the same way “(“and ”) ” do for mathematical expressions, and “\|” means one or the other. So while “C\(a\|A\) T” matches “CaT” or “CAT”, “Ca\|AT” matches “Ca” or “AT”. The special character “\-”, when used inside “\[” and “\]”, indicates a range of acceptable characters, so “\[a\-zA\-Z\]” represents all letters, both uppercase and lowercase. The special character “\-”, when used inside “\[” and“\]”, indicates a range of acceptable characters, so“\[a\-zA\Z\8 ]” represents all letters, both uppercase and lowercase. The special character “\!”, when used to start a set of acceptable characters, negates the set so that the set describes unacceptable characters. In other words, “The special character ” \+” is a suffix, and it means one or more of the previous. So “ab\+” will match “ab”, “abb”, “abbb”, etc., and “\(ab\)\+” will match “ab”, “abab”, “ababab”, etc. The special character “\*” is also a suffix, and it means zero or more of the previous. So “ab\*” will match “ab”, “abb”, “abbb”, but also just “a”. The last suffix is “\#”, and it means that the next character is a digit 0-9 which means that many of the previous. So “ab\#4” matches just “abbbb”. For numbers of occurrences greater than 9, the number must be enclosed by “\(” and “\)”, as in “ab\#\(10\) ” for“abbbbbbbbbb”, and “\#\(60\) ” for 60 spaces.

In an another embodiment of the invention, a translator program is included to translate a program from VBScript to WRS. Alternatively, WRS can use a macro supplied within an application. For example, a macro called “t2c” in Excel converts text to columns. WRS runs the macro as if the user had done it: Alt-F8, type “t2c”, and press Enter:

SET ACTIVEWINDOW FINDWINDOW “Microsoft Excel”

KEYDOWN 18

KEYDOWN 119

WAIT 50

KEYUP 119

KEYUP 18

SYNC

KEYS “t2c\n”

Although the invention has been particularly shown and described with reference to several preferred embodiments thereof, it will be understood by those skilled in the art that various changes in form and details may be made therein without departing from the spirit and scope of the invention as defined in the appended claims.

1. A method for controlling one or more computer applications in a graphical user interface type operating system comprising the steps of:
generating a script file comprising instructions for controlling one or more computer applications;
compiling said script file into a binary language file;
executing said binary language file to control said one or more computer applications according to said instructions.

2. The method of claim 1, further comprising the steps of:
editing said script file to modify said instructions;
recompiling said edited script file into a second binary language file; and
executing said second binary language file to control said one or more computer applications according to said modified instructions.

3. The method of claim 1, further comprising the step of recording all events that occur through the graphical user interface.

4. The method of claim 3, wherein said events comprise mouse and keyboard events.

5. The method of claim 4, wherein said mouse events are selected from the group consisting of: mouse button press, mouse button release, type of mouse button, mouse position, or a combination thereof.

6. The method of claim 4, wherein said keyboard events are selected from the group consisting of: key press, key release, key name, or a combination thereof.

7. The method of claim 3, wherein said events are created directly or indirectly by a user of the graphical user interface.

8. The method of claim 3, wherein said graphical user interface type operating system is a Windows, MacOS, or X-windows based operating system.

9. The method of claim 8, further comprising the step of recording an elapsed time between sequential events and a configuration of each open window, wherein said configuration comprises size, appearance, and position information pertaining to each open window.

10. The method of claim 1, further comprising the steps of:
determining whether said one or more applications are closed; and
based upon said determination, opening said one or more closed applications.

11. The method of claim 1, further comprising the step of storing said script file or said binary language file in a storage medium.

12. The method of claim 1, wherein said step of generating said script file occurs at a first computer and said step of compiling said script file or executing said binary language file occurs at a second computer.

13. The method of claim 12, further comprising the step of transmitting said script or said binary language file from said first computer to said second computer.

14. A system for controlling one or more applications in a graphical user interface type operating system comprising:
an event recorder for recording all events that occur through the graphical user interface and for generating a script file comprising instructions based on said recorded events;
a compiler for compiling said script file into a binary language file; and
an event player for executing said binary language file to control said one or more computer applications according to said instructions.

15. The system of claim 14, wherein said events comprise mouse and keyboard events.

16. The system of claim 15, wherein said mouse events are selected from the group consisting of: mouse button press, mouse button release, type of mouse button, mouse position, or a combination thereof.

17. The system of claim 15, wherein said keyboard events are selected from the group consisting of: key press, key release, key name, or a combination thereof.

18. The system of claim 14, wherein said events are created directly or indirectly by a user of the graphical user interface.

19. The system of claim 14, wherein said graphical user interface type operating system is a Windows, MacOS, or X-windows based operating system.

20. The system of claim 19, wherein said event recorder further records an elapsed time between sequential events and a configuration of each open window, wherein said configuration comprises size, appearance, and position information pertaining to each open window.

21. The system of claim 14, further comprising means for storing said script file and said binary language file in a storage medium.

22. The system of claim 14, further comprising means for sending said script or said binary language file from a first computer to a second computer.

23. A computer-readable medium having computer-executable instructions thereon for controlling one or more computer applications in a graphical user interface type operating system, the instructions comprising modules including:
a recording module for recording all events that occur through the graphical user interface and generating a script file comprising instructions based on said recorded events;
a compiling module for compiling said script file into a binary language file; and
an executing module for executing said binary language file to control said one or more computer applications according to said instructions.

24. The computer-readable medium of claim 23, wherein said events comprise mouse and keyboard events.

25. The computer-readable medium of claim 24, wherein said mouse events are selected from the group consisting of: mouse button press, mouse button release, type of mouse button, mouse position, or a combination thereof.

26. The computer-readable medium of claim 24, wherein said keyboard events are selected from the group consisting of: key press, key release, key name, or a combination thereof.

27. The computer-readable medium of claim 23, wherein said recording module further comprises instructions to determine whether said one or more applications are closed; and
based upon said determination, open said one or more closed applications.

28. The computer-readable medium of claim 23, wherein said events are created directly or indirectly by a user of the graphical user interface.

29. The computer-readable medium of claim 23, wherein said graphical user interface type operating system is a Windows, MacOS, or X-windows based operating system.

30. The computer-readable medium of claim 29, wherein said recording module records an elapsed time between sequential events and a configuration of each open window, wherein said configuration comprises size, appearance, and position information pertaining to each open window.

31. The computer-readable medium of claim 23, further comprising instructions for storing said script file and said binary language file in a storage medium.

32. The computer-readable medium of claim 23, further comprising instructions for sending said script or said binary language file from a first computer to a second computer.
